(19) United States
(12) Patent Application Publication
(10) Pub. No.: US 2009/0038504 A1
(43) Pub. Date: Feb. 12, 2009

(54) POLISHING SLURRY FOR IONIC MATERIALS

(75) Inventor: Hiroshi KUROSAWA, Saitama-shi (JP)

Correspondence Address: BUCHANAN, INGERSOLL & ROONEY PC, POST OFFICE BOX 1404, ALEXANDRIA, VA, 22313-1404, US

(73) Assignee: Kabushiki Kaisha TOPCON, Itabashi-ku (JP)

(21) Appl. No.: 12/250,252

(22) Filed: Oct. 13, 2008

Related U.S. Application Data
(62) Division of application No. 11/302,288, filed on Dec. 14, 2005.

(30) Foreign Application Priority Data
Dec. 22, 2004 (JP) 2004-370958

(51) Int. Cl. C09G 1/02

(52) U.S. Cl. 106/3

(57) ABSTRACT

A polishing slurry is disclosed, which is to be used for polishing an ionic material, the polishing slurry including a dispersant which is to form a nonionic adsorbing layer on a surface of the ionic material. The dispersant may be selected by separately preparing first and second solutions containing first and second different dispersants, immersing test pieces each made of said ionic material into the first and second solutions, respectively, comparing a step between an etched portion and a non-etched portion of the test piece immersed in the first solution with a step between an etched portion and a non-etched portion of the test piece immersed in the second solution, and selecting the dispersant used in the solution in which the test piece having the smaller step is immersed.

### CROSS-REFERENCE TO RELATED APPLICATIONS

This application claims the benefit of Japanese Patent Application No. 2004-370958 filed on Dec. 22, 2004, in the Japanese Intellectual Property Office, and is a divisional application of U.S. application Ser. No. 11/302,288, filed Dec. 14, 2005, the entire contents of which are incorporated herein by reference.

The present invention relates to polishing of ionic materials, and more particularly the invention relates to a polishing slurry suitable for obtaining a polished ionic material with a high-quality mirror surface having super smoothness and less surface defects, a method for selecting a dispersant to be contained in the polishing slurry, a method for determining a mixing concentration of the selected dispersant and a polishing method using said polishing slurry.

More specifically, the invention relates to a technique favorably usable to finish surfaces of materials for deep ultraviolet-range optical lenses and fluoride crystalline materials such as a CaF₂ material, which attach great importance to the surface smoothness and less surface defects.

### BACKGROUND ART

Various polishing slurries have been known as polishing slurries to be used for ionic materials such as the calcium fluoride (CaF₂) material as an optical crystal.

There is a polishing slurry using cerium oxide as such an example (For example, JP-A 2003-503223, pages 2 to 37 and FIG. 4). This publication mentions that the cerium oxide polishing composition is used in a finish polishing step or its polishing prestage step. This publication also describes that colloidal silica, colloidal alumina, colloidal zirconium dioxide, colloidal diamond, etc. are used in finish polishing. It also describes that the pH of the polishing slurry is set to from pH2 to pH12. Further, it discloses that a polishing composition-fixed pad containing fine particles thereof is used. According to the above-recited polishing materials, the well known technique to be used for polishing the optical lenses is applied to the polishing of the optical lenses and performs of fluoride crystals to be finely lithographed.

Another example is a polishing composition using low-viscosity silicone oil (For example, see JP-A 2004-98242, pages 2 to 6, FIG. 2). This polishing composition is aimed at suppressing the formation of a roughed surface in polishing an article made of the crystalline material of fluoride such as CaF₂ through a reaction between the article and an aqueous polishing liquid when the article is to be polished. According to JP-A 2004-98242, the roughened surface to be produced due to the reaction between the article and the polishing liquid can be suppressed by using the low-viscosity silicone oil as an non-aqueous polishing liquid. Further, JP-A 8-19943 discloses another method to prevent a reaction between an article and a polishing liquid. According to this method, when the article is to be polished, fine powder of a crystalline material constituting the article to be polished is preliminarily added to the polishing liquid in such an addition amount of 50% or more of a saturated dissolved amount. This can prevent the reaction between the polishing liquid and the crystalline material, so that pits, surface scratch, burning can be prevented.

Problems to Be Solved by the Invention

In general, when the fluoride-based crystalline material reacts with the aqueous polishing liquid, surface roughness is worsened, surface defects increase and the polished profile changes. When a laser interferometer is used for example, this change can be observed as a change from interference fringes linearly formed at an equal interval to another type of interference fringes formed with ridge lines representing crystalline orientations. The laser interferometer is to macroscopically evaluate the profile of a surface of a sample. A scanning type interference microscope is to evaluate a microstructure such as steps, pits and the like on the surface of the sample.

FIGS. 1(A) and 1(B) show an example of such a change. FIG. 1(A) shows a surface image of a change in surface profile of a CaF₂ single crystal lens 1 immediately after being polished, the surface image being obtained by the laser interferometer. FIG. 1(A) shows change in interference pattern from State la immediately after a lens was polished to State 1b in which a polished shape was changed by a reaction between an aqueous polishing liquid. FIG. 1(B) is a 3D image of the State 1b in which the polished shape was changed. The lens 1 was polished with a CeO₂ slurry at near pH 10 in which an anionic dispersant (polyacrylic acid salt) was added. This CeO₂ slurry is generally used for polishing the optical glass lenses.

The optical axis of the lens 1 is in a [111] axial direction, and triangular pyramid-shaped ridge lines 2 are formed on the surface due to the crystalline orientation. The ridge line 2 is formed in such a size as being clearly discernible. This phenomenon is more likely to occur when the aqueous polishing slurry is used as the polishing composition as compared with another type polishing composition. The occurrence probability of this phenomenon becomes greater in case that the anionic slurry is used as the polishing composition. From the above, it is considered that this is caused by the phenomenon that a chemically removing action does not proceed uniformly on the lens surface, and etching occurs depending upon crystal anisotropy in which the reaction speed differs among crystalline orientations. The reason why the anionic dispersants are frequently used is that many of them are relatively safety and the anionic dispersants attain strong dispersability due to the electrostatic repulsion. However, when the anionic dispersant is used, there is a limit of around 0.3 nm upon the surface roughness in terms of the self average root roughness (rms value). This is attributable to the fact that the chemically removing action with the aqueous polishing liquid does not lead to reduction in surface roughness in the case of the fluoride crystal.

FIG. 2 is a surface image of a CaF₂ single crystal lens 3 after being polished in a method different from that in FIGS. 1(A) and 1(B). The lens 3 was polished with a slurry of diamond dispersed in pure water only. On the surface of the lens 3 are scattered shallow scratch-like defects 4 having depths of around subnanometers. Such minute defects 4 can be observed not with a Normalsky microscope having a vertical resolution of around submicrometer but clearly with a scanning type interference micrometer using white light. It cannot be denied that even such minute defects 4 can affect the span life of the lens in the deep ultraviolet range. According to the polishing with the diamond slurry, the surface of the lens is predominantly mechanically removed with fine diamond particles, and the surface roughness at the rms value can be controlled to 0.2 nm or less. However, since no particular dispersant is added, the abrasive grains are likely to be aggregated and defects 4 such as scratches are likely to occur. Further, it cannot be said that completely no chemically removing action occurs even near a pH neutral area in which the shape is relatively hardly changed to the trigonal pyramid fashion. Therefore, the defects 4 are considered to be latent damages formed by etching.

FIGS. 1(A) and 1(B) and FIG. 2 show examples of the lenses etched with the polishing slurries described in JP-A 2003-503223. In this way, it cannot be said that the polishing slurries, etc. described in JP-A 2003-503223 exhibit particularly excellent polishing characteristics for ionic materials called alkali halides (halides of alkali earth elements) including fluoride crystals.

On the other hand, JP-A 2004-98242 discloses that the low-viscosity silicone oil is used as a polishing liquid so as to prevent the surface of the ionic material called alkali halide (halide of alkali earth element) such as fluoride crystal from being roughened through a reaction between the ionic material and the polishing liquid. However, when the low-viscosity silicone oil is used, it is more difficult to wash the ionic material after polishing, as compared with use of the water-soluble polishing slurry. For this reason, the aqueous polishing slurry is preferably used. In addition, the water-soluble polishing slurry has an advantage that the water-soluble polishing slurry is easily prepared when pure water is used as a solvent.

In order to retard the reaction in which the material is dissolved into the polishing liquid, a fine powder of a crystalline material constituting the article to be polished is preliminarily incorporated into the polishing liquid. However, fine powders must be prepared for corresponding fluoride materials constituting articles to be polished.

### SUMMARY OF THE INVENTION

Under the circumstances, an object of the present invention is to provide a polishing slurry which is used for polishing the ionic materials and affords excellent polished characteristics such as reduction in surface roughness and surface defects.

Further, it is another object of the present invention to provide a method for selecting a dispersant suitable for the polishing slurry to be used for polishing the ionic material and a method for determining a mixing concentration of the dispersant.

Furthermore, it is a further object of the present invention to provide a polishing method which affords excellent polished characteristics upon the ionic material.

Countermeasure to Solve the Problems

In order to solve the above problems, the polishing slurry according to the present invention is to be used for polishing an ionic material, said polishing slurry comprising a dispersant which is to form a nonionic adsorbing layer on a surface of the ionic material.

The polishing slurry according to the present invention may comprise pure water (dispersion medium), diamond powder and the dispersant. As the ionic material to which the polishing slurry according to the present invention can be applied, CaF₂, LiF, MgF₂ and BaF₂ may be recited.

According to the polishing slurry of the present invention, the nonionic adsorbing layer is formed on the surface of the ionic material with the dispersant contained in the polishing slurry. The nonionic adsorbing layer prevents a reaction between the ionic material and the polishing liquid and occurrence of etching. For this reason, when the ionic material is polished with the polishing slurry of the present invention, it is possible to obtain an excellent polished shape and excellent polished properties in which surface roughness and surface defects are reduced.

The dispersant-selecting method according to the present invention, which is adapted to select the dispersant to be incorporated into the claimed polishing slurry, comprises separately preparing a first solution containing a first dispersant and a second solution containing a second dispersant different from the first one, immersing test pieces each made of said ionic material into the first and second solutions, respectively, while a portion of each of the test pieces is masked or not immersed, comparing a step between an etched portion and a non-etched portion of the test piece immersed in the first solution with a step between an etched portion and a non-etched portion of the test piece immersed in the second solution, and selecting the dispersant used in the solution in which the test piece having the smaller step is immersed.

According to the above dispersant-selecting method, since the dispersant is selected by comparing the step formed on the test piece for the first solution with that formed on the test piece for the second solution, the dispersant can be selected, which can effectively prevent the reaction between the ionic material and the polishing liquid.

The dispersant-selecting method according to the present invention, which is adapted to select the dispersant to be incorporated into the claimed polishing slurry, comprises separately preparing a first solution containing a first dispersant and a second solution containing a second dispersant different from the first one, immersing test pieces each made of said ionic material into the first and second solutions, respectively, while a portion of each of the test pieces is masked or not immersed, comparing an average size of pits formed on the test piece immersed in the first solution by etching with that of pits formed on the test piece immersed in the second solution by etching, and selecting the dispersant used in the solution in which the test piece having the smaller average pit size is immersed. The average size of the pits are determined as follows. That is, the pits each have almost an equilateral triangle for one polishing slurry. With respect to one pit, lengths of the three lateral sides are measured, and such measurements are continued with respect to other pits until statistical data giving a statistically significant difference are obtained (for example, 10 pits give 30 statistical data), and the average size of the pits is obtained by averaging the sum of the statistical data (30 data) by 30. With respect to another polishing solution, such an average size of the pits is determined.

According to the above dispersant-selecting method, the size of the pit is regarded as the step formed by etching. Since the dimension of the pit can be observed with a general optical microscope, the dispersant can be more easily selected as compared with a case where the step needs to be observed with a scanning type interference microscope.

A method for determining a mixing concentration of the dispersant according to the present invention, which sets the mixing concentration of the above-selected dispersant to be incorporated into the claimed polishing slurry, comprises preparing a plurality of solutions having different concentrations of the dispersant, respectively, immersing test pieces made of an ionic material into the plurality of the solutions, respectively, while a portion of each of the test pieces is masked or not immersed, determining a relation between a step between an etched portion and a non-etched portion of each of the test pieces immersed in the plurality of the solutions, respectively, and the concentration of a corresponding one of the solutions, and setting the mixing concentration of the dispersant to be used in actual polishing based on the thus determined relation.

According to the above mixing concentration-setting method, the mixing concentration to be used in actual polishing is set based on the relation between the steps formed through etching and the concentration of the solutions. Therefore, the mixing concentration which is suitable for preventing or suppressing the etching due to the reaction between the ionic material and the polishing slurry can be set.

According to the polishing slurry of the present invention, a nonionic water-soluble synthetic polymer is preferably added thereto as the above dispersant.

According to this polishing slurry, the nonionic adsorbing layer can be formed by incorporating the nonionic water-soluble synthetic polymer into the slurry.

The polishing method of the present invention comprises polishing an ionic material with the polishing slurry as mentioned above using the dispersant selected by the above selecting method at a mixing concentration determined by the above mixing concentration-determining method.

According to the above polishing method, an defect-free optical element which is suitable in a deep ultraviolet range and has high precision and excellent surface smoothness can be obtained.

### BRIEF DESCRIPTION OF THE DRAWINGS

For a better understanding of the invention, reference is made to the attached drawings, wherein:

FIGS. (A) and 1(B) show changes in surface profile of a lens made of a CaF₂ single crystal immediately after polishing with a CeO₂ slurry, FIG. 1(A) being a surface image obtained at a measuring wavelength of 632.8 nm with a laser interferometer, and FIG. 1(B) being a three-dimensional image obtained from FIG. 1(A).

FIG. 2 is a surface image obtained by a photographic mode of a scanning type interferometer (trade name : NewView 5000), showing changes in the surface profile of the CaF₂ single crystal lens polished with a diamond slurry.

FIG. 3 is a schematic view illustrating an etching experiment with use of a test piece of the CaF₂ single crystal.

FIG. 4(A) is a surface image of a test piece obtained with a laser interferometer, showing a small step B formed on an etched surface of the test piece, and FIG. 4(B) is an enlarged three-dimensional image obtained by the scanning type interference microscope.

FIG. 5 is a graph showing minute steps B formed on respective test pieces.

FIGS. 6(A) to 6(D) show surface images of non-etched surface (step-standard surface) and etched surfaces of respective test pieces placed in respective solutions.

FIGS. 7(A) and 7(B) are a graph for showing the relationship between the minute steps of the CaF₂ single crystal formed through etching and the concentrations of sodium CMC and a graph for showing a linear regression thereof, respectively.

FIGS. 8(A) and 8(B) are schematic views showing a polishing apparatus and a surface structure of a polishing tool, respectively.

FIG. 9 is a surface image showing changes in surface profile of a semi-spherical lens of a CaF₂ single crystal immediately after polishing with a diamond slurry added with sodium CMC.

FIG. 10 is a surface image of the spherical lens of the CaF₂ single crystal polished with the sodium CMC-added diamond slurry in a photographic mode by the scanning type interference microscope (trade name: NewView 5000), showing a surface profile of the lens.

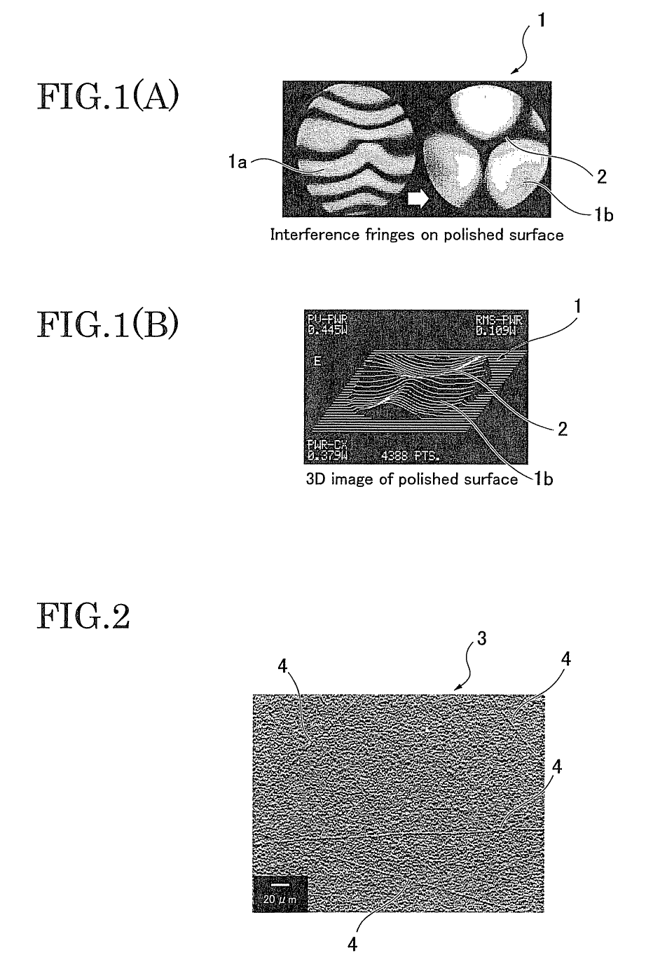

### DETAILED DESCRIPTION OF THE INVENTION

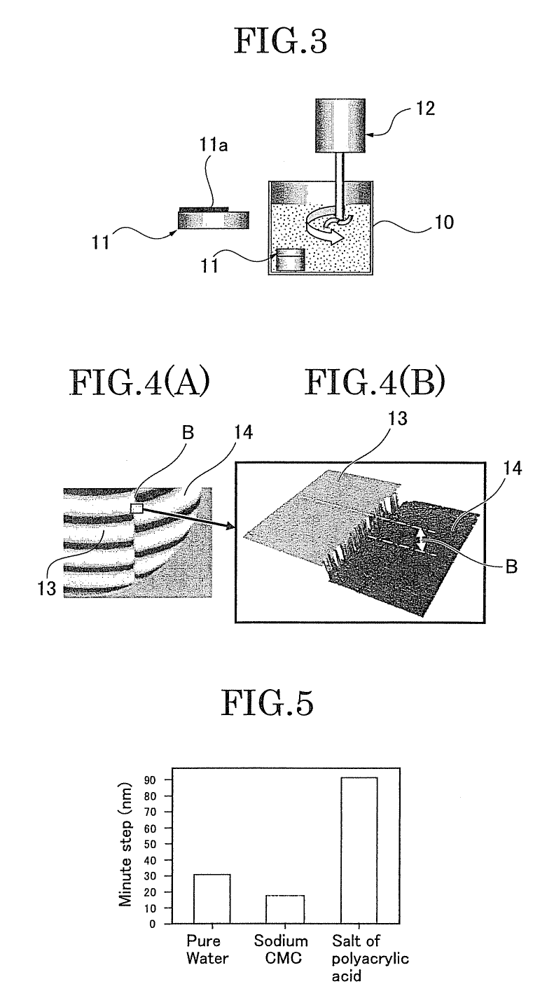

The method for selecting the nonionic water-soluble synthetic polymer to be added to the polishing slurry according to the present invention will be explained. FIGS. 3(A) and 3(B) are schematic views illustrating an etching experiment used for this selecting method.

First, plural water vessels 10 and plural test pieces 11 are prepared. Into the water vessels 10 are poured solutions having different additive dissolved therein. In the present embodiment, three kinds of the solution were prepared, that is, (1) 1-liter pure water (pH7), (2) 1-liter pure water in which 100 mg of a salt of a polyacrylic acid (sodium polyacrylate or the like) is added and dissolved, and (3) 1-liter pure water in which 100 mg of sodium carboxylmethyl cellulose is added and dissolved (near pH 7). Each of these water-soluble synthetic polymer also functions as a dispersant for the grains in the polishing slurry.

Each of the test pieces 11 is made of a CaF₂ single crystal, and mirror-finished. Each of the test pieces 11 has a face (111) for etching which is partially covered with a mask 11a. The mask 11a is made of an aggregated film of a solubilized pitch (a pitch for polishing optical lenses). In the case of the test piece made of the CaF₂ single crystal, 1 g or more of sodium CMC may be used for 1-liter pure water.

The test pieces 11 are immersed in the respective water vessel 10, and each of the solutions is stirred always at 200 rpm with a stirrer 12. This state is kept for 48 hours as it is so as to etch the test pieces 11.

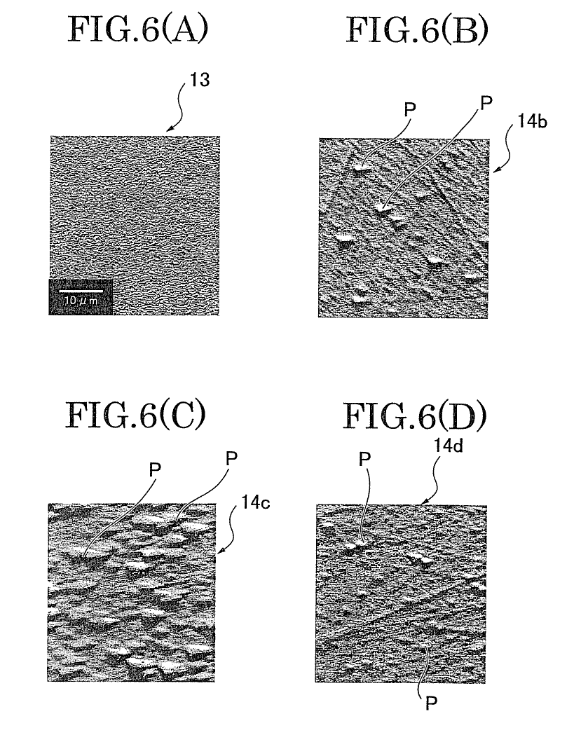

After 48 hours pass, the test pieces 11 are taken out of the respective solutions, and their masks 11a are removed with a solvent. No etching is performed at a portion 13 of the test piece covered with the mask 11a (See FIG. 6(A)). For this reason, the etching-proceeded degree of each of the test pieces 11 can be observed based on the covered portion 13 as a reference. FIG. 4 shows a minute step B formed on the etched face of the test piece 11 between the covered portion 13 and the etched portion 14 in which etching proceeds. The minute step B is observed with a scanning type interference micrometer using white light. The etched surface was also observed with a microscope or the like.

As a result, the etching-proceeded degree of the test piece 11 in the solution of the polyacrylic acid salt is three time as much as that in the pure water. On the other hand, the etching-proceeded degree of the test piece 11 in the sodium CMC solution was a half of that in the pure water. The above comparisons revealed that the sodium CMC prevents or suppresses the reaction between the CaF₂ single crystal and the polishing liquid. In this way, it is possible to select the nonionic water-soluble synthetic polymer which can prevent or suppress the reaction between the CaF₂ single crystal as an ionic material such as a fluoride crystal and the polishing slurry.

Further, the water-soluble synthetic polymer can be selected by observing pits P (minute depressions) formed on each of the test pieces instead of comparing the etching-proceeded degrees. FIG. 6(A) shows a surface image of the covered portion 13 for each of the test pieces 11. FIGS. 6(B) to 6(D) show surface images of the etched portions 14b, 14c and 14d of the test pieces 11 in the solutions (1) to (3), respectively. When the face (111) of the CaF₂ single crystal was etched, triangular pyramids P and latent scratches were formed. The dimension (a length of a side) of the pit P is proportional to the etching-proceeded degree of the test piece 11. Since the dimensions of the pits P are from a few μm to around 20 μm, so that they can be observed with an ordinary optical microscope. From this, even if there is unavailable a high-precision apparatus which can measure the minute steps B, the water-soluble synthetic polymer capable of preventing or suppressing the reaction between the CaF₂ single crystal and the polishing slurry can be selected by utilizing the dimensions of the pits P instead of the minute steps B.

For example, JP-B 2820328 (high-speed finish-polishing agent) in the name of SUN TOOL adapts the construction in which a water-soluble synthetic polymer such as sodium CMC is added to the polishing slurry. However, the object of this publication differs from that of the present invention in that the polymer is added to impart viscosity upon the polishing slurry.

Next, how to set the mixing concentration of sodium CMC thus selected will be explained.

Similarly to the etching experiments, plural water vessels 10 and plural test pieces 11 are prepared (See FIG. 3). Solutions of different amounts of sodium CMC each dissolved in 1-liter pure water, respectively, are prepared, and poured into the water vessels 10, respectively. Each of the test pieces 11 is immersed into the respective one water vessel 10, and the minute step B formed on the etched face (See FIG. 4) is observed.

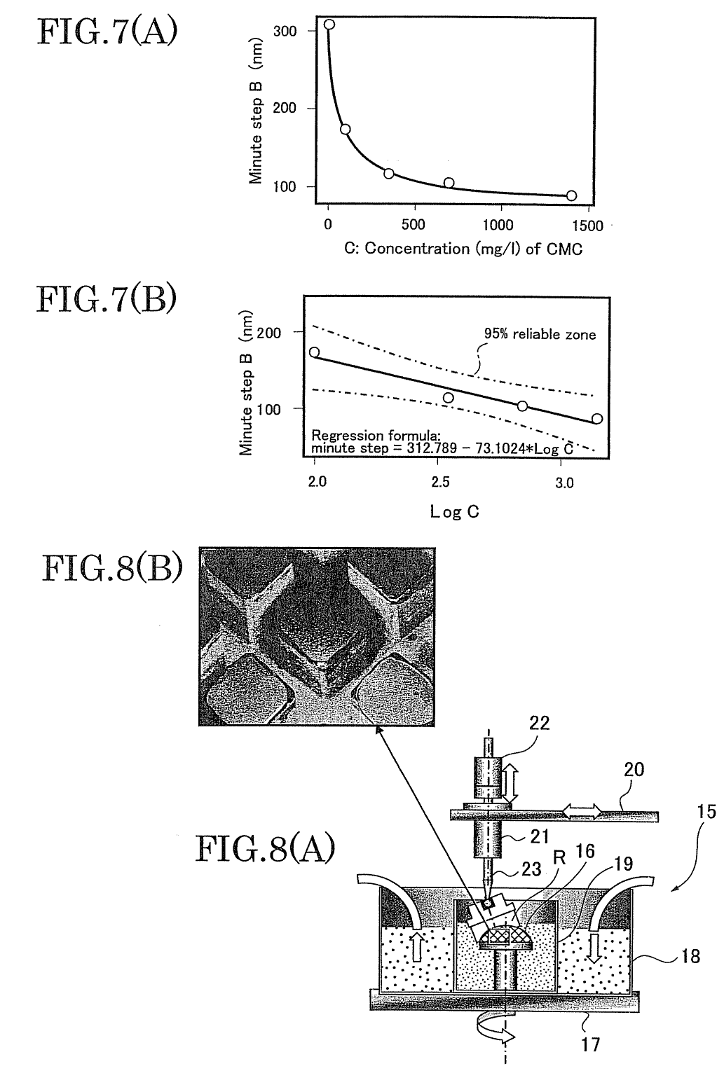

As shown in FIG. 7(A), the dimension of the minute step B gradually decreases as the addition amount of the sodium CMC is increased. When the concentration of sodium CMC is expressed by logarithm, linear regression is possible between the concentration of sodium CMC and the minute step B (See FIG. 7(B)). From this linear regression, when the addition amount of sodium CMC per 1-liter pure water was 1400 mg, the dimension of the minute step B was ¼ of that in the case of pure water. In this way, it is possible to set an appropriate mixing concentration of the sodium CMC from the correlation between the concentration of sodium CMC and the etched amount.

A diamond slurry was prepared by adding and dissolving 1400 mg of the sodium CMC selected by the above selection method into 1-liter pure water so that the mixing concentration thereof may be that set by the above mixing concentration-setting method. A diamond powder to be used for this purpose was used in an amount of 2 g, while its grain size distribution was not more than 0.2 μm. A lens R of the CaF₂ single crystal is polished with this diamond slurry (See FIGS. 8(A) and 8(B)).

FIG. 8(A) shows a polishing apparatus 16 equipped with a known polishing tool 15. The polishing tool 15 has a solubilized pitch-aggregated film in a thickness of not more than 0.3 mm on a semi-spherical substrate having grooves. The polishing apparatus 16 comprises a turntable 17, an outer vessel 18, an inner vessel 19, a reciprocating plate 20, a linear guide 21, a load 22, and a stick pin 23. The outer vessel 18 is placed on the turntable 17. The inner vessel 19 is placed inside the outer vessel 18. The polishing tool 15 is arranged inside the inner vessel 19. The reciprocating plate 20 is arranged in parallel and spaced from the turntable 17. The reciprocating plate 20 is provided with the linear guide 21, the load 22 and the stick pin 23. The lens R of the CaF₂ single crystal is arranged at a tip of the stick pin 23. The CaF₂ single crystal lens R faces the polishing tool 15 inside the inner vessel 19. Water at a constant temperature is circulated in the outer vessel 18. The above-mentioned diamond slurry is poured into the inner vessel 19.

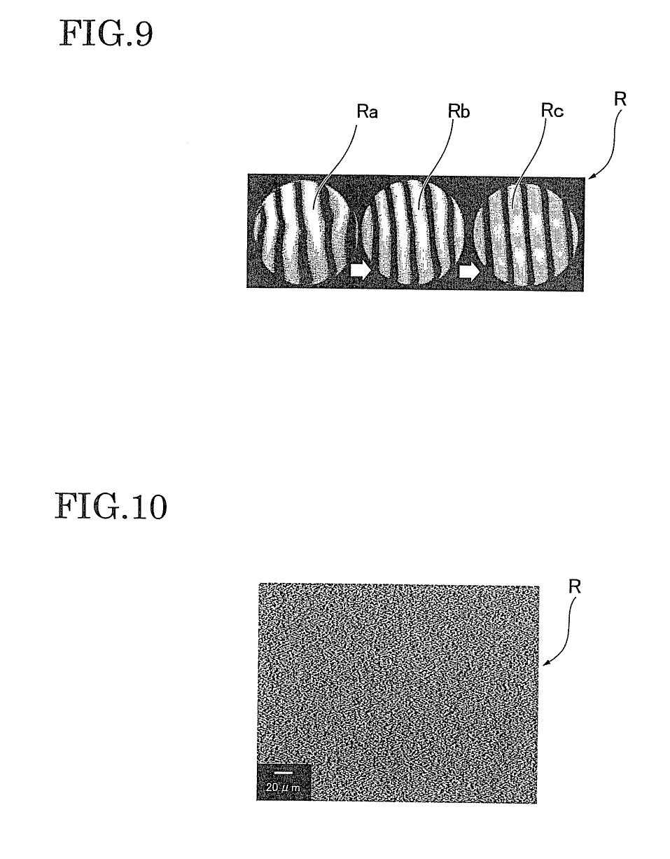

FIG. 9 shows changes in the surface profile of the CaF₂ single crystal lens R immediately after being polished with the diamond slurry by the polishing apparatus 16. FIG. 9 gives the surface images obtained by a laser interferometer. The interference fringes change from State Ra immediately after polishing, State b to State c. FIG. 10 shows the surface image of the lens R of the CaF₂ single crystal. As shown in FIG. 9, the surface profile of the CaF₂ single crystal lens R did not change to triangular pyramid pattern. If a medium diameter size (40 to 70 mm in diameter) is taken for the lens R, the sphericity: λ/30 to λ/50 could be obtained. The surface roughness (rms value) could be attained at not more than 0.2 nm. As shown in FIG. 10, the surface of the lens was almost free from defects. The reason for this is considered that a nonionic adsorbing layer was formed on the surface of the CaF2 single crystal lens R by adding 1400 mg of sodium CMC to the diamond slurry, and this adsorbing layer prevented or suppressed the reaction between the CaF₂ single crystal lens R and the solvent of the diamond slurry.

As mentioned above, the reaction between the ionic material to be polished and the polishing slurry can be prevented or suppressed by incorporating the nonionic adsorbing layer-forming dispersant such as the ionionic water-soluble synthetic polymer as the dispersant into the polishing slurry according to the present invention. Thereby, the surface roughness and the surface defects can be reduced as compared with the conventional polishing slurries.

In addition, according to the polishing slurry of the present invention, the nonionic adsorbing layer is formed on the surface of the ionic material by adding the nonionic adsorbing layer-forming dispersant such as the ionionic water-soluble synthetic polymer thereto. Since this polymer adsorbing layer prevents the reaction between the ionic material to be polished and the polishing slurry, fine powders of nonionic-bond materials to be polished need not be prepared as in case of the conventional polishing slurries in which the fine powder of the ionic bond materials is dissolved to prevent the above reaction.

According to the claimed method for selecting the dispersant to be added into the polishing slurry, the nonionic adsorbing layer-forming dispersant such as the nonionic water-soluble synthetic polymer is selected based on the proceeded degree of the etching on the ionic material. Therefore, when the thus selected dispersant is incorporated into the polishing slurry, the reaction between the ionic material and the polishing slurry can be effectively prevented or suppressed.

According to the claimed method for determining the mixing concentration of the dispersant to be added to the polishing slurry in the present invention, the mixing concentration is set depending upon the proceeded degree of etching on the ionic material. Therefore, when the polishing slurry having the thus set mixing concentration of the dispersant is used, the reaction between the ionic material and the polishing slurry can be appropriately prevented or suppressed.

According to the polishing method with use of this polishing slurry, the optical elements having high precision, excellent surface smoothness and no defects can be obtained. Such optical elements are favorably used in the deep ultraviolet range.

Thus, the polishing slurry of the present invention can be used for polishing the ionic materials including the fluoride crystals, and can attain excellent polished characteristics such as reduction in the surface roughness and the surface defects.

In the above Embodiments, the nonionic adsorbing layer-forming dispersant such as the ionionic water-soluble synthetic polymer: sodium CMC is selected as the dispersant, but the invention is not limited thereto so long as the reaction between the ionic material and the polishing slurry can be prevented or suppressed.

What is claimed is:

1. A polishing slurry to be used for polishing an ionic material, said polishing slurry comprising a dispersant which is to form a nonionic adsorbing layer on a surface of the ionic material.

2. The polishing slurry claimed in claim 1, wherein said dispersant is a nonionic water-soluble synthetic polymer.

3. The polishing slurry claimed in claim 2, wherein the nonionic water-soluble synthetic polymer is sodium carboxylmethyl cellulose (CMC).
